(19) United States
(12) Patent Application Publication
(10) Pub. No.: US 2003/0048310 A1
(43) Pub. Date: Mar. 13, 2003

(54) Graphical environment

(76) Inventor: Matthew William Hart, Auckland (NZ)

Correspondence Address: YOUNG & THOMPSON, 745 SOUTH 23RD STREET 2ND FLOOR, ARLINGTON, VA, 22202

(21) Appl. No.: 10/240,776

(22) PCT Filed: Apr. 6, 2001
(86) PCT No.: PCT/NZ01/00054

(30) Foreign Application Priority Data
Apr. 7, 2000 (NZ) 503877

(51) Int. Cl. G09G 5/00

(52) U.S. Cl. 345/810

(57) ABSTRACT

An interactive graphical environment includes a scape (e.g., landscape, streetscape, virtualscape) wherein elements of interest on the scape can be activated. The elements are linked (e.g., hyperlinked) to additional information including additional graphical environments, documents, web sites or images providing more information relating to the elements.

### FIELD OF THE INVENTION

This invention relates to the generation of utilisation of a graphical environment representing a geographical area.

### BACKGROUND

Finding information on the web which relates to a specific geographical area is extremely difficult. In particular difficulties are posed when trying to identify number visual features relating to a specific geographical. Difficulties are magnified by search engines which currently search based on word requests. There is no allowance on the net for the searching an area to see what features—natural and man-made—are located therein. Nor is there any way to find a shop or place on a specific road, street, avenue.

### OBJECT

It is an object of the present invention to allow the viewing of an electronic geographical area by or at least to provide the public with a useful choice.

### STATEMENT OF INVENTION

In one aspect the invention relates to a graphical environment comprising a scape wherein elements of interest are activated and linked to additional information.

Preferably the scape comprises a collated series of images.

More preferably the additional information includes additional graphical environments, documents, web sites or images, which provide more information relating to said element activated or another aspect of the element.

More preferably the environment is stored electronically on a computer server, compact disk DVD, tape, hard disk, floppy disk or other digital storage means.

In a further aspect the invention relates to a method of creating an graphical environment.

Preferably the electronic graphical environment comprises a number of activated elements.

More preferably the activated elements are hyperlinked to additional graphical environments images or websites.

More preferably the graphical environment displays a composite image of a geographical scape.

More preferably the geographical scape is selected from the group including street scapes, city scapes, landscapes, seascapes, skyscapes and virtual scapes.

More preferably the images are linked to a map and search engine.

In a further aspect the invention relates to a method of making of a graphical environment including the following steps:

Collecting a series of images of a geographical scape.

Converting the images to an electronic format;

Editing and combining the images so they form a complete picture of the geographical scape;

Identifying elements within the image of interest;

Electronically linking the identified elements to other images or to information relating particularly to that element.

Preferably said images are obtained by photography using, emulsion films, digital camera, video cameras or digital video cameras, or are illustrations, paintings, collages, models or a combination thereof.

Preferably the geographical scape is selected from the group including street scapes, city scapes, landscapes, seascapes, skyscapes and virtual scapes.

More preferably images are converted to an electronic format including jpg, bmp, tif.

More preferably the images are collated or overlapped to form a complete picture of the scape.

More preferably the collated images are edited to achieve a uniform look so factors including light, colour, and scale.

Preferably the additional information will be made up of one or more additional graphical environments, documents, web sites or images, which provide more information relating to said element activated or another aspect of the element.

### DETAILED DESCRIPTION

The invention will now be described by reference to a particular application. This application enables users to view a streetscape as if the users were standing on the street looking across the road. In much the same way as a person on a street side may be unable to see the entirety of the street the whole street may not be visible on the screen at once. This is facilitated by a number of steps including:

1. Obtaining a series of images of street frontage of the target area.

2. If necessary converting these images to an electronic format.

3. Merging the images to obtain a scape or a continuous picture of the street front.

4. Editing the images to provide a consistent colour, contrast, light and appearance.

5. Activating elements within the scape that are of particular interest.

6. Collecting information about the activated elements.

7. Generating links from the activated elements to a data file containing the information collected, to other web addresses, to close up views of the elements or to other graphical environments.

1. Obtaining a Series of Images of Street Frontage of the Target Area.

The first step in the process is to collect a series of images of the target area. This can be done in a number of ways including but not limited to taking photographs on emulsion film, sketching and drawing the street scene, taking digital photos of the street, taking video footage of the street. In addition it is possible to create a virtual street where the series of images are not taken of an existing street but are arrived at by creative means for example drawings, paintings, CAD images and so forth.

Those skilled in the art will appreciate there are an innumerable number of ways the images can be collected. The critical factor is the images are of a high quality and are able to be converted into an electronic format if they do not originate in such.

2. Conversion of Images Into an Electronic Format

If the images are in a non electronic form it will be necessary to convert them into an electronic format. Again there are a number of ways this may be done. The most common way is to scan either the image itself or the negative where the image is a photograph and save it as a picture file. It is desirable that a consistent file type is used for each scape. Suitable file types include jpg, bmp, tif and the like.

Those skilled in the art will appreciate there are a large number of ways this can be done. The aim of this step is to obtain an image in an electronic format where that image can be manipulated using image manipulation software.

3. Merging the Images to Obtain a Scape or Continuous Picture of the Street Front

Once the images are collected and converted to an electronic format they must be collated or merged to provide a continuous strip or scape. It will be appreciated by those skilled in the art that this may be done by a number of ways.

It is desirable the images be collated to form a complete picture of the scape. This collation can be done by use of generally available image processing and editing programmes by way of example Corel Draw and Adobe PhotoShop.

The collation essentially requires the different images to be arranged together that the individual pictures combine to form the larger picture or scape.

4. Editing the Images to Provide a Consistent Colour, Contrast, Light and Appearance.

Once collation is complete the features contained within the images can be edited. The editing involves two main aspects: editing the scale, brightness, contrast and so forth or the individual images to ensure that the final collated image has a consistent look and editing various elements of the images.

Editing the images to ensure consistency between them and therefor in the final scape is done using generally available software.

In addition elements within the images can be edited. By way of example where the images contain bill boards bearing an advertisement the advertisement can be changed advertise different product.

5. Activating Elements within the Scape of Particular Interest

Element contained within the scape may be activated by hyperlinking it to a related data file, close up, scape, or website and the like. In this way the scape becomes a graphical environment with which a user can interact.

By way of example the a particular element of the image may be linked to a close view of the image for example in a street scape a close up of a shop window to allow window shopping. This close up may be further linked to give access to an image of the interior of the shop. Those skilled in the art will appreciate it is possible to link more than one scape together and the interior of a shop may itself be a separate scape.

Alternatively the elements may be hyperlinked to an alternate web address belonging the shop which exists in the road or in the alternative the web address of a company which has advertised in the street scape.

6. Collecting Information

The information that is provided in the links and the like must be collected from the relevant parties. For example the shops in the street may provide website information or restaurants may provide copies of their menu.

7. Generating Links

Those skilled in the art will appreciate the graphical environment and linkages between activated elements and the other websites, screen shots or other information are written using HTML. It is also possible to establish these links using Java and similar languages.

It is desirable the language used be one which is compatible with widely available internet browsers such as Netscape and Internet Explorer.

Storage of the Graphical Environment

The graphical environment information is stored on a central server. It may be accessed via a network which may be an intranet or the internet. Alternately the environment and attendant information may be stored on any digital media such as a CD, DVD, floppy disk, hard drive and the like.

Horizontal and Vertical Movement

It will be apparent to these skilled in the art that the entire graphical environment will not be viewable in its entirety as a single screen shot. The user is able to navigate around the environment to those elements that are of interest. This is done in a number of ways primarily horizontal movement down the street is achieved by use of the scroll bar. Similarly movement up or down is achieved by way of the vertical scroll bar. In addition as described above users are able to investigate elements in the environment by clicking on them.

By way of an example vertical movement on screen may be achieved by way of an elevator. You would be able to scroll floor by floor through a multi level department store. Alternatively you can click on the floor or storey you want to go to and virtually enter the floor. From each floor you can also see the view. Everything you see will be part of the graphical environment and contain activated elements. The higher you go, the more you can see and therefore click on. For example if you can see Takapuna from the top of the Sky Tower then you can click on it then go shopping or touring on the North Shore.

The key to this invention is that you are able to click on elements to find out more information. For example if the graphical environment displays a bush walk you could click on a tree and information about the tree will be presented.

It would be appreciated by those skilled in the art that alterations and modifications may be made to the forgoing without departing from the spirit or scope of the invention.

### ADVANTAGES

It is envisaged the present invention will allow searching of the map for elements including navigation, with the help of land marks and visual views. In addition it is envisaged this will enable people who are strangers to a city to select an area within a city in which they wish to stay.

This invention will also allow people who are unable to travel to a particular area to go online and make a virtual tour of the area and make purchases, inspection or exploration.

### VARIATIONS

It is envisaged that many variations may be made to the above without departing from the essential features of the invention.

For example the above Road Works example has focused on a street scape. However the invention is equally applicable to seascapes or landscapes. In addition the description above has focused on the horizontal axis however vertical and surround environments may be arrived at by the use of the present invention. While the above example focuses on a real street scene it is possible to arrive at a virtual scene, for example may be a virtual shopping mall or arena or park. Obviously the same process foundation image collection, an application could be applied to the landscapes, seascapes, waterscapes, skyscapes and park areas etc.

The scroll down technology has many different applications (roads, streets, avenues, beaches, bays, buildings etc). Wherever there is an area that needs representing this technique can be implemented whether vertical or horizontal eg. trans rail.

A scroll can be implemented that takes you from the top of the North Island to the bottom of the South Island for example you could take the tour along Highway 1 or down the main trunk line. Another application would be Coast to Coast. Tour New Zealand—would enable you to tour the entire coastline of New Zealand for example you could click on Milford and scroll along the coast to your desired point.

In addition the invention may be applied on a larger scale to allow mapping of entire cities, searching for areas where a user may wish to visit for example by way of local features or amenities or by way of costs of accommodation or accessibility are also envisaged.

In addition to the environment being useful over a web environment it is envisaged smaller areas will be available as discrete units outlining particular areas or streets of interest or allowing greater detail of particular areas to be included. In particular it is envisaged that CD or DVD versions of the software may be available to provide localised information.

In addition to the environment being established in HTML or Java it is envisaged it will also able to be established using other languages suitable for use with technology other than computers, for example, with play stations.

Throughout the description and claims of this specification the word “comprise” and variations of that word, such as “comprises” and “comprising”, are not intended to exclude other additives, components, integers or steps.

We claim:

1. A graphical environment comprising a scape wherein elements of interest are activated and linked to additional information.

2. A graphical environment as claimed in claim 1 wherein the scape comprises a collated series of images.

3. A graphical environment as claimed in any of claims 1 or 2 wherein the additional information includes additional graphical environments, documents, web sites or images, which provide more information relating to said element activated or another aspect of the element.

4. A graphical environment as claimed in any of claims 1 to 3 wherein the environment is stored electronically on a computer server, compact disk DVD, tape, hard disk, floppy disk or other digital storage means.

5. A method of creating an graphical environment.

6. A method as claimed in claim 5 wherein the electronic graphical environment comprises a number of activated elements.

7. A method as claimed in claim 5 or claim 6 wherein the activated elements are hyperlinked to additional graphical environments images or websites.

8. A method as claimed in any of claims 5 to 7 wherein the graphical environment displays a composite image of a geographical scape.

9. A method as claimed in any of claims 5 to 8 wherein the geographical scape is selected from the group including street scapes, city scapes, landscapes, seascapes, skyscapes and virtual scapes.

10. A method as claimed in any of claims 5 to 9 wherein the images are linked to a map and search engine.

11. A method of making of a graphical environment including the following steps:
a) Collecting a series of images of a geographical scape.
b) Converting the images to an electronic format;
c) Editing and combining the images so they form a complete picture of the geographical scape;
d) Identifying elements within the image of interest;
e) Electronically linking the identified elements to other images or to information relating particularly to that element.

12. A method as claimed in claim 11 wherein said images are obtained by photography using, emulsion films, digital camera, video cameras or digital video cameras, or are illustrations, paintings, collages, models or a combination thereof.

13. A method as claimed in any of claims 11 or 12 wherein the geographical scape is selected from the group including street scapes, city scapes, landscapes, seascapes, skyscapes and virtual scapes.

14. A method as claimed in any of claims 11 to 13 wherein images are converted to an electronic format including jpg, bmp, tif.

15. A method as claimed in any of claims 11 to 14 wherein the images are collated or overlapped to form a complete picture of the scape.

16. A method as claimed in any of claims 11 to 15 wherein the collated images are edited to achieve a uniform look so factors including light, colour, and scale.

17. A method as claimed in any of claims 11 to 16 wherein the additional information will be made up of one or more additional graphical environments, documents, web sites or images, which provide more information relating to said element activated or another aspect of the element.

18. An graphical environment substantially as herein described.

19. A method of generating an graphical environment substantially as herein described.

20. A graphical environment generated by the method claimed in any of claims 4 to 16.
